(19) United States
(12) Patent Application Publication
(10) Pub. No.: US 2005/0090928 A1
(43) Pub. Date: Apr. 28, 2005

(54) Method and kit for modifying articles of clothing

(76) Inventor: Suzanne Gibson, Boca Raton, FL (US)

Correspondence Address: Michael A. Slavin, Esq.;McHale & Slavin, P.A., 2855 PGA Boulevard, Palm Beach Gardens, FL, 33410, US

(21) Appl. No.: 10/691,687

(22) Filed: Oct. 23, 2003

(51) Int. Cl. G06F 19/00

(52) U.S. Cl. 700/133

(57) ABSTRACT

The instant invention relates to a method of modifying articles of clothing to include user-created images. The objectives are accomplished in accordance with the invention by the provision of a method and kit containing precut adhesive backed printable cloth covers releasably adhered to a liner sheet and software adapted for interfacing with preexisting computer software and computer peripherals for modifying clothing accessories adapted for receiving the printable cloth covers.

### FIELD OF THE INVENTION

This invention relates to a method and kit for temporarily modifying various types of articles of clothing, e.g. shoes, belts and the like, to match user created colors and patterns; particularly to a kit containing a plurality of adhesive backed printable cloth covers releasably adhered to a liner sheet and software for interfacing with preexisting computer software and computer peripherals.

### BACKGROUND OF THE INVENTION

Computer systems having the ability to function in accordance with the now well known “desktop publishing” have been provided for a number of years as the power and capability of computers and printers have increased. While such systems vary somewhat, they each typically rely upon a computer having a processor unit and supporting a display monitor together with a printer. In many instances, the printer is preferably a color printer to provide a more professional looking output of printed media. Desktop publishing software may be obtained from a number of software providers which is used by the computer to create images at the user's selection upon the display monitor which are then passed to the printer for a hard copy of the selected design. A great deal of power and flexibility is provided in such systems including the ability to store a plurality of image elements for selection and inclusion into a given to-be-printed image. In most instances, the computer system utilizes a mouse device and a menu-driven software arrangement in which much of the work done to assemble the image on the display is accomplished by simple “point and click” mouse operation.

With the advent of computer sketch pads, digitizers, scanners, digital video cameras and still cameras, computer images now combine many of the traits of drawings, paintings, photographs and photocopies, yet are easy for most people to create. Examples of computer-creation of images are disclosed in U.S. Pat. Nos. 4,635,132, 4,687,526, 4,923,848, 5,009,626, 5,109,281, 5,148,196, 5,343,386, and 5,623,581, the disclosures of which are incorporated herein by reference.

Thus, such systems are capable of providing a virtually endless variety of so-called hard copy output. While originally such systems were used entirely to print images upon paper, in recent years it has been found equally advantageous to print images upon a peel-off sticker bearing media. Thus, sheets of paper shaped in accordance with standard sheet sizes are supported adhesively upon an impervious carrier similar to conventional peel-off labels or stickers. As these sticker or label sheets are passed through the printer, selected images are placed upon the stickers or labels at the appropriate location by the desktop publishing software.

Not surprisingly, practitioners in the art have been quick to utilize this powerful type of software together with improved faster and more powerful computers to solve various problems and undertake various business activities as well as various amusing, educational or entertaining activities.

Business activities generally include time savers such as adhesive labels. Adhesive labels are well known in the art and various types of laminated label constructions have been employed to provide a user with labels that can be attached to various types of substrates such as documents, pages in a magazine, message boards and the like. Typically, such laminated constructions are made of two plies, one of which is die-cut to form a plurality of labels while the other acts as a carrier sheet to which the die-cut sheet is peelably secured so that the die-cut labels can be removed from the carrier sheet and applied to a substrate.

In order to be applied to a substrate, an adhesive is applied to the back of each label. The adhesive is of a type that releases from the carrier sheet while remaining on the label. Various types of barrier coatings have also been provided on the carrier sheet to allow release of the labels with sufficient adhesive on their backs allow the labels to be applied to a substrate.

Some examples of educational and entertainment activities which utilize sticker type media include, U.S. Pat. No. 5,524,932 issued to Kalisher sets forth a STICKER-BASED METHODS OF MAKING A PERSONALIZED CHILDRENS' STORY BOOK using preprinted books with blank areas on various pages. A transparent sticker having personalized text thereon is applied to the blank areas to create a personalized story line in the book.

U.S. Pat. No. 5,556,339 issued to Cohen sets forth a COMPUTER PICTURE TOY FOR INFANTS AND VERY YOUNG CHILDREN which provides audio-visual stimuli directed to the creation of a picture in response to input by an infant or very young child.

U.S. Pat. No. 5,623,581 issued to Attenberg sets forth a DIRECT VIEW INTERACTIVE PHOTO KIOSK AND IMAGE FORMING PROCESS FOR SAME having a photo booth coupled to a computer for combining the subject's image with a plurality of background images and for printing multiple copies thereof.

U.S. Pat. No. 5,487,010 issued to Drake, et al. sets forth a BUMPER STICKER PRINTING MACHINE having an arcade-style enclosure, a computer board and program, a monitor and touch screen and means for feeding a succession of vinyl bumper sticker material to a printer. The customer puts money into the machine and then selects a bumper sticker style which is then printed.

It is also known in the prior art to create various types of appliques which may be applied to articles of clothing and/or accessories. The appliques are generally either permanently attached to the article of clothing or they may be temporary attached via buttons, hook and loop, snaps etc.

U.S. Pat. No. 6,110,558 issued to Billingsly et al. teaches clothing bearing retroreflective applique that has a binder layer onto which a retroreflective layer is disposed. The retrorflective layer includes a layer of optical elements and a metal reflective layer, and a binder layer that includes a thermoplastic copolymer which contains carboxyl groups.

U.S. Pat. No. 6,161,224 to Tuetken teaches a decorative applique that is removably affixed to a garment including collars, pockets and accessories (such as hats, pocketbooks and shoes). The removable applique is adapted for mounting at multiple locations for any one of a number of selected appliques with a spring action clip similar to those in children's berrettes that can be selectively affixed to the outer surface of a garment. The clip having a pivotal elongated attaching bar that enable s the clip to be fastened to either the garment collar or the user's hair and fashion accessories.

U.S. Pat. No. 6,367,088 to Bergeman teaches a garment embellishment having no attachment means. The embellishment may take the place of a more formal necktie, bolo tie, or scarf and may be easily transported in a pocket, purse or briefcase so that it is immediately available to help dress-up casual clothing. The embellishment may be removably attached to clothing by use of double-sided adhesives, hook and loop fasteners, pins, snaps, button loops or other buttoning attachments.

Other applique patents known to Applicant are U.S. Design Patent 428,687 illustrating a lighted sport design on an athletic shoe and U.S. Design Patent 428,687 illustrating a shoe applique.

While the foregoing described prior art devices have improved the art and in some instances enjoyed commercial success, there remains nonetheless a continuing need in the art for evermore improved, amusing, interesting and entertaining features to utilize newly developed powerful computers for enhancing everyday life.

Therefore what is needed in the art is a method and kit which allows these exciting and popular methods of image creation to be incorporated for the customizing articles of clothing, e.g. shoes, belts, handbags, hats and the like. The kit should be simple to use by young and old, with minimal instruction and supervision, and should interface with a standard computer and peripherals to match or create colors and/or patterns which may be easily applied to various types of articles of clothing. The printable cloth covers should be releasable from the articles of clothing, so that the printed cover may be removed from the clothing at any time and replaced with a different printed cover.

### SUMMARY OF THE INVENTION

The objectives are accomplished in accordance with the invention by the provision of a kit containing precut adhesive backed printable cloth covers releasably adhered to a liner sheet and software adapted for interfacing with preexisting computer software and computer peripherals for modifying various types of articles of clothing adapted for receiving the printable cloth covers.

In operation, a computer is operatively coupled to a printer and a monitor and includes input devices such as a keyboard and mouse in addition to peripheral devices such as a scanner or digital camera and a color printer. A CD-ROM disk is loaded into the computer which bears software adapted for interfacing with desktop publishing type operating software housed within the processor unit of the computer. The interaction provided by the software allows the user to input colors and/or patterns from the peripheral devices or select various standard design elements for printing upon peel and stick type printable cloth laminate sheets using the color printer. The interfacing software may further provide a preview display in which a selected article of clothing is displayed having the selected design placed thereon. The printable cloth laminate includes a releasable backing sheet which can be removed from the printable cloth to expose a layer of pressure sensitive adhesive. The printed cloth can be attached to a portion of the selected article of clothing allowing the article of clothing to be customized to the users needs. The covers are positioned on the backing sheet in a adjacent relationship having a suitable precut shape and size to approximate a portion of the article of clothing, for example a foot strap on a standard pair of slide, sandal or mule type shoes. The covers are removed from the backing sheet to expose the pressure sensitive adhesive. The exposed pressure sensitive adhesive is adhered to the surface of the article of clothing to create a bond between the cover and the clothing. The covers may be easily customized and printed for application to the article of clothing to suit a particular function or activity. The construction of the covers allow a first cover to be easily removed or a second cover to be placed directly over the top of a first cover where modification of an existing customized article of clothing is desired.

By utilizing the aforementioned method and kit, a single set of clothing can be easily and quickly personalized to suit a variety of occasions.

Accordingly, a primary objective of the instant invention is to teach a laminated sheet of printable cloth containing a plurality of removable precut cloth covers which can be passed through a standard ink applying print mechanism and thereafter be peeled away from a backing sheet and applied to an article of clothing.

Another objective of the instant invention is to teach a method for modifying articles of clothing to match user-created colors and/or patterns.

Yet another objective of the instant invention is to teach a method for using a computer operatively coupled to a monitor and input devices such as a keyboard and mouse and peripheral devices such as a color printer to create printed cloth covers adapted for customizing articles of clothing.

Still another objective of the instant invention is to teach a method of inputting colors and patterns into a computer using peripheral devices such as a scanner or digital camera and a color printer and utilizing a software adapted for interfacing with desktop publishing type software to position the colors and patterns on a precut laminated printable cloth which can be used to customize articles of clothing.

Other objectives and advantages of this invention will become apparent from the following description taken in conjunction with the accompanying drawings wherein set forth, by way of illustration and example, certain embodiments of this invention.

The drawings constitute a part of this specification and include exemplary embodiments of the present invention and illustrate various objectives and features thereof.

### BRIEF DESCRIPTION OF THE DRAWINGS

FIG. 1 sets forth a perspective view of a computer system having a desktop publishing system stored therein together with the present invention game software being installed in a CD-ROM format;

FIG. 2 sets forth an exemplary display of selected articles of clothing prior to customization;

FIG. 3 sets forth a display of a selected image designs which may be chosen from a plurality of designs to be printed onto a printable cloth sticker for decorating articles of clothing;

FIG. 4 sets forth a display showing the selected article of clothing together with the selected designs applied thereto; and

FIG. 5 sets forth a perspective view of a shoe having a printed cloth cover secured thereto.

### DETAILED DESCRIPTION OF THE PREFERRED EMBODIMENT

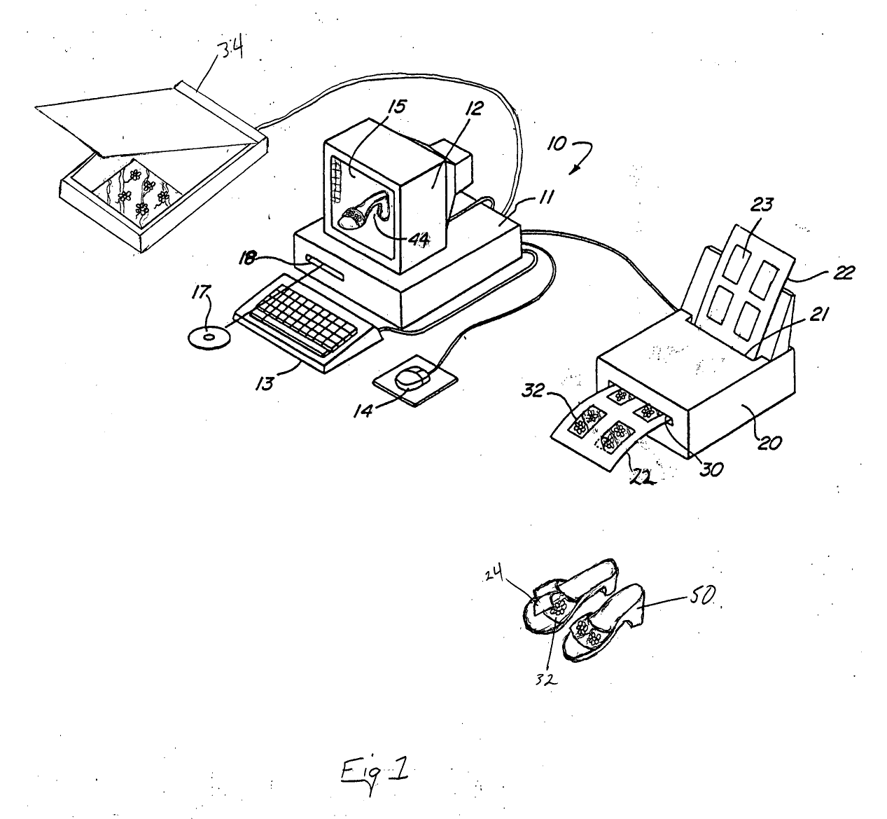

FIG. 1 sets forth a perspective view of a computer system running under the control of a desktop publishing type software of conventional fabrication and generally referenced by numeral 10. Computer system 10 is further fabricated in accordance with conventional fabrication techniques and includes a processor unit 11, a monitor 12 having a display screen 15 together with a keyboard 13. For purposes of illustration, an image 40 is displayed upon screen 15. In further accordance with conventional fabrication techniques, computer system 10 includes mouse 14 operatively coupled to processor 11 in a conventional manner. A printer 20 which, in its preferred fabrication, comprises a color printer is operatively coupled to processor unit 11 and includes a stock input 21 and a printed sheet output 30.

In accordance with the present invention, a sheet of blank printable cloth laminate 22 having die cut sections for peel-off covers 23 is shown being inputted to printer 20. Also shown in FIG. 1 is a sheet of printable cloth laminate stock 22 having passed through printer 20 and having received images 32 upon the peel-off cover cutout 23 portions thereof. While the peel-off covers 23 are preferably constructed from a cloth type material other materials well known in the art suitable for passing through a printer may be utilized including, but not limited to, papers, textured papers, embossed papers or suitable combinations of paper and cloth.

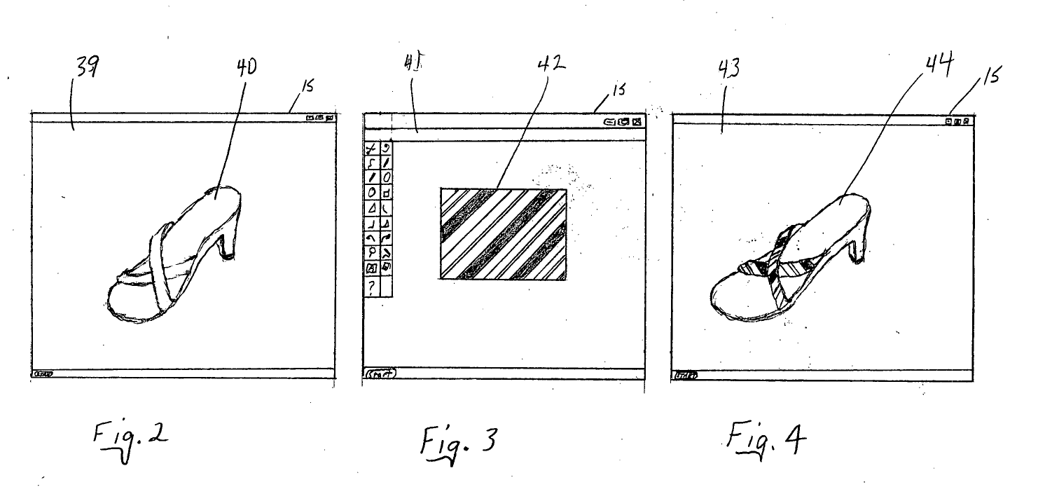

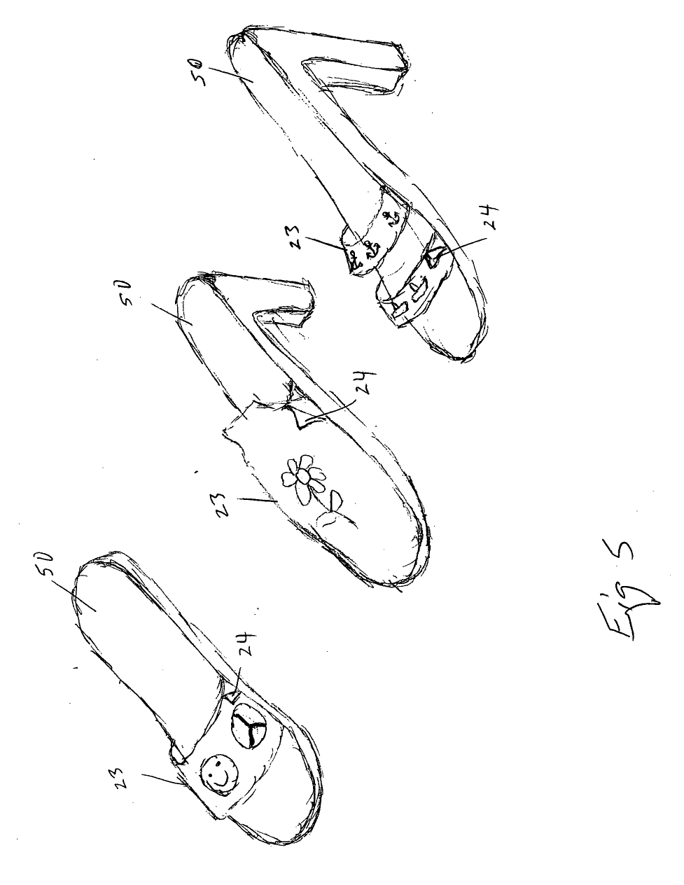

In operation and in accordance with the present invention, a CD-ROM disk 17 is inserted into a drive input 18. The software supported upon CD-ROM 17 forms the operational software of the present invention by which the clothing accessory customization is carried forward. Once CD-ROM 17 is loaded within processor unit 11, computer system 10 is ready for operation of the present invention. In the preferred embodiment of the present invention, inputs to processor unit 11 are provided using keyboard 13 and/or mouse 14 to display a selected shoe image 40 (FIG. 2) upon display screen 15. Alternative methods of providing inputs to the processor well known in the art may also be utilized, e.g. digitizers, digital tablets and the like. Thereafter, inputs are provided to processor 11 which toggle the display image upon display screen 15 between the article of clothing display containing shoe image 40, design display 41 containing a user-created image 42 (FIG. 3), and a preview display 43 containing output image 44 (FIG. 4). Inputs are also provided to copy and paste, insert, download and import an image into the design display screen 41. The images may be inserted or copied from clip-art, downloaded from an internet connection, or imported from peripheral devices well known in the art including but not limited to scanners 34, copiers, digital cameras, and the like. The user then operates mouse 14 to manipulate and/or alter the user image 42 as desired for eventual application to an article of clothing corresponding to the type of clothing article displayed in the article clothing display image 40 on the prior screen.

Thereafter and as is described below in FIGS. 2, 3 and 4, the user having selected an article of clothing and a user-created design to be used on printable cloth laminate applicable to the article of clothing, implements a print cycle. In accordance with the software on CD-ROM 17, the print operation of printer 20 under control of processor 11 is formatted to correspond to the size and location of various ones of said blank peel-off covers 23 on blank laminate printable cloth sheet 22. As printer 20 processes blank sheet 22, images such as image 32 are printed upon the peel-off covers 23 of the laminate sheet. Once the desired printed covers have been obtained, the user may then apply them to the selected article of clothing to provide an aesthetically enhanced and customized clothing for any occasion.

FIGS. 2, 3 and 4 set forth sequential displays appearing upon display screen 15 (FIG. 1) in carrying forward the above-described operation of the present invention to produce peel-off covers 23 having a user-created design which may be applied to a selected article of clothing. More specifically, referring to FIG. 2 display screen 15 shows an article of clothing 40 illustrated herein as a shoe which may be selected by conventional selection means such as name input or pull down menu using keyboard 13 or point and click operation of mouse 14. The article of clothing type may be selected from CD-ROM 17 which is constructed and arranged to contain a wide variety of articles of clothing which may include but should not be limited to shoes, belts, hats and purses, or an article of clothing may be downloaded from an external source such as an internet connection.

Referring to FIG. 3 display screen 15 illustrates design display including a user-created image 42. The user may select and alter the user-created image as desired for printing upon a blank cover 23 for application to a selected article of clothing. Once again, in the preferred embodiment of the present invention, mouse 14 (seen in FIG. 1) is utilized to select a particular image from among design images contained on CD-ROM 17. Alternatively, an image may be inserted into screens 39, 41, 43 from various means well known in the art capable of communicating with a computer, for example an image may be imported from a peripheral device or downloaded from the internet.

FIG. 4 sets forth a display 43 which appears upon display screen 15 having the selected article of clothing image 40 (FIG. 2) shown together with selected user image 42 (FIG. 3). The ability of the present invention system to provide a display of the article of clothing along with its selected user-created design images allows the user to “preview” the aesthetic effect of utilizing a printed cloth cover bearing the user-created design image upon the article of clothing. If the user prefers to relocate the user-created design image 42, the user is able to click upon image 42 using mouse 14 (seen in FIG. 1) and “drag” design image 42 to a different location upon the article of clothing image 40. Alternatively, the user may reverse the operation and return to display 41 of FIG. 3 and select or import an alternate design.

If the user elects to continue and print the cloth covers 23, the user inputs a print command to processor unit 11 (seen in FIG. 1) and loads a blank sheet of printable cloth stock 22 into printer 20 (FIG. 1). The result of the selection process and the previewing of the combined displays of the selected article of clothing and the selected design is communicated to printer 20 from processor 11 (FIG. 1) to initiate the printing process. As described above, a blank sheet of printable cloth laminate stock (sheet 22 in FIG. 1) is processed within the printer to provide a plurality of peel-off covers 23 bearing selected image 42. The user may then peel-off each cover in the manner shown in FIG. 1 and apply the self-adhesive cover 23 to the intended surface of an article of clothing. In this manner, the article of clothing may be greatly enhanced in appearance by a plurality of images supported upon printable cloth material and adhering to the accessory upon various surfaces thereof. In the preferred fabrication of the present invention, the adhesive used in the peel-off cover material provides a releasable adhesive which adequately adheres to the clothing accessory surface while being releasable or peelable for easy removal and replacement by a different cover.

FIG. 5 sets forth a perspective view of one type of an article of clothing, e.g. various shoes 50 constructed in accordance with conventional fabrication techniques. In accordance with the invention, shoes 50 have received at least one self-adhesive printable cloth cover 23. In further accordance with the present invention and using the process described above, the covers 23 bear selected images thereon. For purposes of illustration, cover 23 is shown peeled upwardly at portion 24 thereof to illustrate the removal of the present invention covers for replacement by other covers or to return shoes 50 to their initial appearance.

What has been shown is a method and kit for producing printed cloth covers for various types of articles of clothing in which the user is presented with a series of displays facilitating choice of an article of clothing structure together with a plurality of designs each capable of being selected and printed upon one or more peelable self-adhesive covers. In accordance with an important aspect of the present invention, the computer software provides for display of the article of clothing structure having the selected cover images placed thereon. As a result, the user is able to preview the resulting appearance of the clothing accessory choice and the selected designs for the cover in combination.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A method of aesthetically altering articles of clothing with user created images using a computer system having a display monitor, one or more input devices and a printer, said method comprising the steps of:
providing at least one article of clothing defining a plurality of surfaces;
providing a plurality of printable cloth laminate sheets, wherein said printable cloth laminate sheet is die cut into one or more sections to define a plurality of peelable blank covers within said printable cloth laminate sheet;
displaying on a display monitor said at least one article of clothing;
displaying on a display monitor at least one image design;
selecting at least one image design for use on said article of clothing to provide a selected image design;
displaying on a display monitor said at least one article of clothing having said at least one selected image design thereon;
printing said at least one selected image design upon said blank cover to produce a printed cover; and
applying one or more of said printed covers to one or more surfaces of said at least one clothing accessory;
whereby said at least one article of clothing is aesthetically altered.

2. The method of aesthetically enhancing at least one article of clothing as set forth in claim 1 wherein said steps further include:
providing a peripheral device constructed and arranged for importing or storing at least one image design;
displaying on said display monitor at least one imported image design obtained from said peripheral device;
selecting an imported image design for use on said at least one article of clothing to provide at least one selected imported image design;
displaying on a display monitor said at least one article of clothing having said at least one selected imported image design thereon;
printing said at least one selected imported image design upon said blank covers to produce printed cover cutouts; and
applying one or more of said printed cover cutouts to one or more surfaces of said at least one article of clothing.

3. The method of aesthetically enhancing at least one article of clothing as set forth in claim 2 wherein said peripheral device imports or stores at least one image design from the world wide web.

4. The method of aesthetically enhancing at least one article of clothing as set forth in claim 1 wherein said printable cloth laminate sheets include a printable cloth sheet releasably adhered to a release sheet, said printable cloth sheet including a first indicia side for printing thereon and a second adhesive side having pressure sensitive adhesive thereon, said release sheet having at least one side coated with a release agent, whereby said pressure sensitive adhesive releasably adheres said printable cloth sheet to said release sheet, whereby said pressure sensitive adhesive remains on said printable cloth sheet upon removal of said printable cloth sheet from said release sheet.

5. The method of aesthetically enhancing at least one article of clothing as set forth in claim 1 wherein said at least one article of clothing is a pair of shoes.

6. The method of aesthetically enhancing at least one article of clothing as set forth in claim 5 wherein said die cut printable cloth covers are generally rectangular in shape and generally sized to fit a foot strap on a standard slide type shoe.

7. The method of aesthetically enhancing at least one article of clothing as set forth in claim 5 wherein said die cut printable cloth covers are generally rectangular in shape and generally sized to fit a foot strap on a standard sandal type shoe.

8. The method of aesthetically enhancing at least one article of clothing as set forth in claim 5 wherein said die cut printable cloth covers are generally shaped and generally sized to fit a front portion on a standard mule type shoe.

9. The method of aesthetically enhancing at least one article of clothing as set forth in claim 1 wherein said at least one article of clothing is a belt.

10. The method of aesthetically enhancing at least one article of clothing as set forth in claim 1 wherein said at least one article clothing is a hat.

11. The method of aesthetically enhancing at least one article of clothing as set forth in claim 1 wherein said at least one article of clothing is a purse.

12. The method of aesthetically enhancing at least one article of clothing as set forth in claim 1 wherein said printable cloth sheet includes embossing thereon.

13. The method of aesthetically enhancing at least one article of clothing as set forth in claim 2 wherein said peripheral device is a scanner, wherein said scanner is constructed and arranged for communication with said computer system, whereby said scanner is constructed and arranged to scan an object and transfer a digital image of said object to said computer system.

14. The method of aesthetically enhancing at least one article of clothing as set forth in claim 2 wherein said peripheral device is a color copier, wherein said color copier is constructed and arranged for communication with said computer system, whereby said color copier is constructed and arranged to scan an object and transfer a digital image of said object to said computer system.

15. The method of aesthetically enhancing at least one article of clothing as set forth in claim 2 wherein said peripheral device is a digital camera, wherein said digital camera is constructed and arranged for communication with said computer system, whereby said digital camera is constructed and arranged to photograph an object and transfer a digital copy of said photograph to said computer system.

16. A kit for aesthetically altering at least one article of clothing with user created images using a computer system having a display monitor, one or more input devices, desktop publishing software and a printer comprising:
at least one printable cloth laminate sheet, wherein said printable cloth laminate sheet includes a printable cloth sheet layer and a release sheet layer, said printable cloth sheet layer including a first indicia side for printing thereon and a second adhesive side having pressure sensitive adhesive thereon, said release sheet layer having at least one side coated with a release agent, whereby said pressure sensitive adhesive releasably adheres said printable cloth sheet to said release sheet, whereby said pressure sensitive adhesive remains on said printable cloth sheet upon removal of said printable cloth sheet from said release sheet;
a software program adapted for interfacing with said preexisting desktop publishing software, wherein said software is constructed and arranged to set forth sequential displays appearing upon said display monitor for carrying forward the operations required to produce a printed cloth cover having a user-created design which may be applied to said at least one article of clothing;
whereby said printable cloth sheet layer is removable from said release sheet layer and whereby said pressure sensitive adhesive remains on said printable cloth sheet layer upon removal of said printable cloth sheet layer from said release sheet layer and whereby said exposed second adhesive side of said printable cloth sheet layer is adhered to said at least one article of clothing, whereby said at least one article of clothing is modified to contain a user-created image thereon.

17. The kit for aesthetically altering at least one article of clothing with user created images as described in claim 16 wherein said printable cloth sheet layer is die cut into one or more sections to define a plurality of peelable blank cloth covers within said printable cloth laminate sheet.

18. The kit for aesthetically altering at least one article of clothing with user created images as described in claim 17 wherein said peelable blank cloth covers within said printable cloth laminate sheet are generally shaped and generally sized to fit a surface on a belt.

19. The kit for aesthetically altering at least one article of clothing with user created images as described in claim 17 wherein said peelable blank cloth covers within said printable cloth laminate sheet are generally shaped and generally sized to fit a surface on a hat.

20. The kit for aesthetically altering at least one article of clothing with user created images as described in claim 17 wherein said peelable blank cloth covers within said printable cloth laminate sheet are generally shaped and generally sized to fit a surface on a purse.

21. The kit for aesthetically altering at least one article of clothing with user created images as described in claim 17 wherein said peelable blank cloth covers within said printable cloth laminate sheet are generally shaped and generally sized to fit a surface on a pair of shoes.

22. The kit for aesthetically altering at least one article of clothing with user created images as described in claim 21 wherein said peelable blank cloth covers within said printable cloth laminate sheet are generally rectangular in shape and generally sized to fit a foot strap on a standard slide type shoe.

23. The kit for aesthetically altering at least one article of clothing with user created images as described in claim 21 wherein said peelable blank cloth covers within said printable cloth laminate sheet are generally rectangular in shape and generally sized to fit a foot strap on a standard sandal type shoe.

24. The kit for aesthetically altering at least one article of clothing with user created images as described in claim 21 wherein said peelable blank cloth covers within said printable cloth laminate sheet are generally shaped and generally sized to fit a front portion on a standard mule type shoe.

25. The kit for aesthetically altering at least one article of clothing with user created images as described in claim 17 wherein said printable cloth sheet includes embossing thereon.

26. The kit for aesthetically altering at least one article of clothing with user created images as described in claim 16 wherein said adhesive on said second side of said printable cloth sheet is a hot melt adhesive;
whereby said peelable cloth covers are adhered to a surface of said at least one article of clothing by heating said peelable cloth covers.
